(19) United States
(12) Patent Application Publication
(10) Pub. No.: US 2026/0289322 A1
(43) Pub. Date: Sep. 24, 2026

(54) KNOWLEDGE EXPLORATION METHOD AND SYSTEM BASED ON GENERATIVE CHAIN OF THOUGHT AND FEEDBACK MECHANISM

(71) Applicant: SHANGHAI MOLE COMPUTER TECHNOLOGY CO., LTD., Shanghai (CN)

(72) Inventor: Gang CHEN, Shanghai (CN)

(21) Appl. No.: 19/570,113

(22) Filed: Mar. 17, 2026

(30) Foreign Application Priority Data
Mar. 20, 2025 (CN) 202510331228.7

(51) Int. Cl. G06N 3/092

(52) U.S. Cl. CPC G06N 3/092

(57) ABSTRACT

A knowledge exploration method and system based on a generative chain of thought and feedback mechanism are provided. The method includes receiving a multi-modal query input from a user, performing intent analysis to identify core requirements; pre-processing the multi-modal query and extracting key information, decomposing complex problems into multiple sub-problems or sub-tasks; dynamically constructing a hierarchical reasoning path based on the generative chain of thought, annotating each step of the reasoning path with a logical basis; optimizing the priority of reasoning paths through dynamic weight allocation, combined with a meta-reinforcement learning framework to dynamically adjust reasoning strategies online and optimize reasoning paths; using a causal reasoning analysis tool to verify reasoning paths, generating counterfactual paths to correct erroneous nodes; outputting structured text and visualizing the reasoning process, and optimizing model parameters in real-time based on multi-player feedback aggregation using game theory.

### CROSS REFERENCE TO RELATED APPLICATIONS

The present disclosure claims the priority to the Chinese patent application with the filing No. 202510331228.7, entitled “KNOWLEDGE EXPLORATION METHOD AND SYSTEM BASED ON GENERATIVE CHAIN OF THOUGHT AND FEEDBACK MECHANISM” and filed on Mar. 20, 2025 with the Chinese Patent Office, the contents of which are incorporated herein by reference in their entirety.

### TECHNICAL FIELD

The disclosure relates to the field of artificial intelligence (AI), specifically, to cross-technical fields of intelligent query and knowledge reasoning technologies, and more particularly to a knowledge exploration method and system based on a generative chain of thought and feedback mechanism.

### BACKGROUND ART

Existing intelligent query systems mostly employ static rules or single-modal input, relying on keyword matching and preset reasoning templates, and have the following limitations:
1. Traditional systems cannot dynamically adjust reasoning paths according to contexts. When faced with complex problems (such as conflicts in legal provisions or fusion of multi-modal inputs), retrieval efficiency is low and results are singular.

Existing AI models often require significant computing resources and time when handling long-text, high-complexity query tasks. Due to the large volume of data, traditional reasoning processes are slow, especially when facing high-concurrency query requests, the system's response speed significantly decreases, leading to poor user experience.

In complex situations, such as legal regulations or academic papers, existing models are prone to problems such as inaccurate extraction of key information, logical reasoning errors, or deviations in context understanding. In such cases, the returned results may not be sufficiently accurate or relevant, making it difficult to meet users' needs for high-quality knowledge services. Existing technologies struggle to capture deep semantic associations in long texts or multi-round interactions, and cannot accurately match user intent, especially in professional fields such as law and healthcare.

Most existing technologies employ static rules or fixed reasoning path generation strategies, making the reasoning process prone to deviating from expected paths. This instability affects the accuracy and consistency of knowledge derivation, especially when handling changing query requests, making it difficult to ensure stable results.
2. Traditional feedback mechanisms rely only on offline user behavior data and cannot optimize reasoning paths through real-time interaction, limiting system response speed and personalization level.

Existing systems lack a mechanism to adjust reasoning parameters or paths in real time based on feedback after reasoning is completed. As the application environment changes, the model cannot be updated in time to maintain high performance, and system performance gradually declines over time, making it difficult to continuously provide efficient reasoning services.

Existing models often exhibit ‘black box’ characteristics, and the output results lack a detailed display of the reasoning process. Especially in high-risk fields such as law and healthcare, users expect to understand the specific steps and basis of reasoning, but this need cannot be effectively met in existing technologies, reducing user trust in the system's results.

Therefore, there is an urgent need for those skilled in the art to solve the above limitations of intelligent query systems.

### SUMMARY

In view of this, the disclosure provides a knowledge exploration method and system based on a generative chain of thought and feedback mechanism, which can effectively solve the intelligent query and reasoning challenges in complex scenarios, achieving precise, real-time, and credible knowledge services.

To achieve the above objective, the disclosure adopts the following technical solutions:

In a first aspect, an embodiment of the disclosure provides a knowledge exploration method based on a generative chain of thought and feedback mechanism, which includes the steps as follows.
S10, receiving, from a user, a multi-modal query input, performing intent analysis to identify core requirements, writing topics or problem focuses;
S20, pre-processing the multi-modal query and extracting key information, decomposing complex problems into multiple sub-problems or sub-tasks;
S30, dynamically constructing a hierarchical reasoning path based on the generative chain of thought according to the multiple sub-problems or sub-tasks, annotating each step of the reasoning path with a logical basis;
S40, optimizing priority of the reasoning path through dynamic weight allocation, combined with a meta-reinforcement learning framework to dynamically adjust reasoning strategies online and optimize the reasoning path;
S50, verifying the reasoning path, based on the optimized reasoning path, using a causal reasoning analysis tool, generating counterfactual paths to correct erroneous nodes;
S60, outputting structured text and visualizing the reasoning process, and optimizing model parameters in real-time based on multi-player feedback aggregation using game theory.

In one embodiment, in step S40, optimizing the priority of the reasoning path through dynamic weight allocation includes the steps:

Dynamically calculating weights of nodes in the reasoning path according to task context, semantic similarity and node importance, the weight being calculated by the following formula:

$${w}_{i} = \frac{exp ( sim ( q , {n}_{i} ) / τ}{{\sum }_{i = 1}^{j} exp ( sim ( q , {n}_{i} ) / τ}$$

wherein, the wᵢ represents the weight of reasoning node nᵢ; q represents the current query task; the nᵢ represents the i-th reasoning node; j represents the number of all reasoning nodes in the current path; sim(q, nᵢ) represents the semantic similarity between the current task q and the reasoning node nᵢ; τ represents a temperature coefficient for controlling path exploration intensity;
optimizing selection of the path according to the multiple nodes decomposed from the reasoning path, each node corresponds to a sub-task, thereby maximizing a total reward value through a reward model; wherein, the formula for maximizing the total reward value is as follows:

$${P}^{*} = arg {max}_{p} ( {\sum }_{i = 1}^{k} {w}_{i} \cdot {R}_{i} ( T ) )$$

wherein, T represents the query task, Rᵢ (T) represents the reward value of node i, k represents the number of nodes in the current path; p represents a dynamically adjusted normalized weight coefficient, p∈[0,1].

In one embodiment, in step S40, optimizing the priority of the reasoning path through dynamic weight allocation further includes:
fusing multi-modal input information, achieving semantic alignment of text and images through an alignment loss function, the loss function being defined as:

$${L}_{align} = - \frac{1}{N} {\sum }_{a = 1}^{N} {\sum }_{b = 1}^{M} {II}_{ab} \cdot log ( \frac{exp ( cos ( {f}_{T} ( {T}_{a} ) , {f}_{I} ( {I}_{b} ) / τ}{{\sum }_{k = 1}^{M} exp ( cos ( {f}_{T} ( {T}_{a} ) , {f}_{I} ( {I}_{k} ) / τ} )$$

wherein, II_{ab}∈{0,1} represents a modality correlation indicator function, which is 1 when the text Tₐ is related to the image I_{b}, otherwise 0; f_{T} (·) and f_{I}(·) represent a text encoder and an image encoder respectively, outputting normalized embedding vectors; I represents the k-th sample in the image modality, k≠b; cos(·,·) represents cosine similarity, τ represents a temperature coefficient; N represents the number of text samples, M represents the number of image samples.

In one embodiment, in step S40, the meta-reinforcement learning framework dynamically adjusts reasoning strategies online, including:
offline meta-pre-training, using a MAML framework to pre-train a model on a cross-domain task set;
online fine-tuning generating adversarial samples through real-time user feedback to dynamically update model parameters;
integrating a composite reward mechanism having interpretability indicators, balancing reasoning accuracy, efficiency and interpretability through a multi-objective reward function.

In one embodiment, in step S50, verifying the reasoning path using a causal reasoning analysis tool including:
generating counterfactual queries when reasoning results deviate, comparing an actual path with a counterfactual path to locate erroneous nodes and trigger correction;
defining causal strength between nodes by embedding causal probability edges in knowledge, and calculating a logical consistency score, a task relevance score, a case support score and an interpretability score to enhance reasoning credibility and interpretability.

In one embodiment, in step S50, verifying the reasoning path using a causal reasoning analysis tool further includes:
in each step of generating the reasoning path, optimizing a reasoning chain through a reward model, the reward mechanism being as follows:

$$R = {w}_{1} \cdot Accuracy + {w}_{2} \cdot Efficiency - {w}_{3} \cdot Re sources$$

w₁ represents a weight coefficient for accuracy; The Accuracy represents an accuracy score of the reasoning chain; w₂ represents a weight coefficient for efficiency; the Efficiency represents an efficiency score of the reasoning chain; w₃ represents a weight coefficient for resource consumption; Resources represents a resource consumption score of the reasoning chain.

In one embodiment, in step S60, optimizing model parameters in real-time based on multi-player feedback aggregation using game theory includes:
quantifying user feedback contributions based on a Shapley value algorithm of game theory, filtering low-quality or malicious feedback, coordinating multiple user opinions to optimize the reasoning path;
utilizing the meta-reinforcement learning framework to process aggregated feedback information in real time, dynamically adjusting the reasoning path and model parameters.

In a second aspect, an embodiment of the disclosure further provides a knowledge exploration system based on a generative chain of thought and feedback mechanism, comprising:
a data input module, configured to receive a multi-modal query input from a user, perform intent analysis to identify core requirements, writing topics or problem focuses;
a semantic processing module, configured to pre-process the multi-modal query and extract key information, decompose complex problems into multiple sub-problems or sub-tasks;
a reasoning engine module, configured to dynamically construct a hierarchical reasoning path based on the generative chain of thought according to the multiple sub-problems or sub-tasks, annotate each step of the reasoning path with a logical basis;
a dynamic reasoning path module, configured to optimize priority of the reasoning path through dynamic weight allocation, combined with a meta-reinforcement learning framework to dynamically adjust reasoning strategies online and optimize the reasoning path;
a causal reasoning analysis module, configured to, based on the optimized reasoning path, use a causal reasoning analysis tool to verify the reasoning path, generate counterfactual paths to correct erroneous nodes;
a result output and feedback optimization module, configured to output structured text and visualize the reasoning process, and optimize model parameters in real-time based on multi-player feedback aggregation using game theory.

Based on the above technical solutions, compared with the prior art, the disclosure has the following technical advantages:
Accuracy: Through dynamic weight allocation and causal reasoning, it can accurately capture the deep logical relationships of the text, avoiding missing key information.
Real-time performance: The online optimization framework based on meta-reinforcement learning ensures rapid adaptation to dynamic changes in the text.
Credibility: The results are enhanced through causal reasoning and interpretability, meeting the strict requirements of high-risk fields.
Efficiency: The overall architectural design improves the computational efficiency of large-scale reasoning tasks, making it suitable for real-time applications in complex scenarios.

The disclosure, by integrating multiple advanced AI technologies, deeply integrates a reasoning path generation mechanism based on dynamic weight allocation, meta-reinforcement learning, a reasoning path optimization framework based on meta-reinforcement learning, causal reasoning, a multi-player feedback aggregation algorithm based on game theory, and interpretability enhancement technologies, significantly improving the performance of intelligent query and knowledge reasoning systems, providing reliable technical support for knowledge services in complex scenarios.

### BRIEF DESCRIPTION OF DRAWINGS

To explain the technical solutions in the embodiments of the disclosure or in the prior art more clearly, the drawings required for describing the embodiments or the prior art will be briefly introduced below. Apparently, the drawings in the following description are merely embodiments of the disclosure, and for those of ordinary skill in the art, other drawings can be obtained based on the provided drawings without creative efforts.

FIG. 1 is a flowchart of a knowledge exploration method based on a generative chain of thought and feedback mechanism provided by the disclosure.

FIG. 2 is a technical roadmap of knowledge exploration based on a generative chain of thought and feedback mechanism provided by the disclosure.

FIG. 3 is a system architecture diagram of knowledge exploration based on a generative chain of thought and feedback mechanism provided by the disclosure.

### DETAILED DESCRIPTION OF EMBODIMENTS

The technical solutions in the embodiments of the disclosure will be clearly and completely described below with reference to the accompanying drawings in the embodiments of the disclosure. Apparently, the described embodiments are only a part of the embodiments of the disclosure, but not all of them. Based on the embodiments in the disclosure, all other embodiments obtained by those of ordinary skill in the art without creative effort shall fall within the protection scope of the disclosure.

The complex scenarios targeted by the disclosure involve a class of texts having the following characteristics:
Formal characteristics: formal, rigorous long texts with complex structures, containing multi-level logical relationships; the texts are dense with terminology, have high semantic ambiguity, and impose high requirements on information extraction and reasoning; the text content is frequently updated dynamically, requiring the system to have efficient real-time updating and adaptation capabilities.
Application characteristics: strong multi-dimensional correlation, reasoning needs to integrate multiple information sources; the scenarios involve high-risk decisions, requiring extremely high accuracy and transparency of reasoning results; different users have different interpretation needs for the same text, requiring support for personalized reasoning services; some scenarios require multidisciplinary collaborative reasoning to process multi-source, multi-modal information.

These characteristics are concentrated in formal, rigorous long texts such as legal regulations, academic papers, technical specifications/standard documents, government reports, contract documents, medical guidelines, financial reports, user manuals, etc. Their core uses include:
Legal regulations: quickly locate key information in legal provisions, assist professionals in compliance analysis or legal consultation.
Academic research and technical documents: support knowledge point mining and literature review generation in academic papers, accelerate technology developers' understanding and citation of technical specifications.
Business and financial analysis: parse financial reports and contract documents, assist in identifying risk clauses or performing financial data analysis.
Medical health: interpret medical guidelines and case data, provide reference for clinical decision-making.
Policy interpretation: process government reports and social policy documents, extract policy priorities and implementation suggestions.

In modern society, legal regulations, academic papers, technical specifications/standard documents, government reports, contract documents, medical guidelines, financial reports, user manuals, etc., are all lengthy formal and rigorous texts. Such texts have the following significant characteristics and patterns:
Large text scale, complex structure: Texts in these scenarios are often lengthy and have complex internal structures, containing multiple levels of logical relationships, such as progressive, parallel, and conditional relationships between clauses.
Dense terminology, high semantic ambiguity: Formal texts often contain a large number of professional terms, industry abbreviations, and vague expressions, which increase the difficulty of information extraction and logical reasoning.
Strong multi-dimensional correlation: Different paragraphs or chapters in the text are often highly correlated, and reaching a single conclusion may require synthesizing information from multiple sources for reasoning.
Frequent dynamic updates, fast version iteration: Texts such as laws, regulations, and technical standards are often revised frequently due to policy adjustments or technological innovation, which imposes high requirements on the real-time updating capability of the knowledge base.
Application scenarios involve high-risk decisions: In fields such as finance, healthcare, and law, any reasoning error may lead to significant economic losses or legal disputes, thus requiring extremely high accuracy, reliability, and interpretability of the system.
Significant differences in diverse user needs: Different users may have divergent interpretations of the same text. For example, a legal advisor may focus on the scope of application of legal clauses, while a technical person may focus on the specific execution steps of operational specifications.
Strong cross-domain synergy: For example, interpreting medical guidelines may require combining clinical experience, pharmacological knowledge, and individual patient conditions. This multidisciplinary intersection makes simple keyword matching insufficient, and deep reasoning capabilities must be leveraged.

In summary, the pattern of these scenarios lies in their comprehensive challenges to the knowledge integration capability, reasoning accuracy, dynamic adaptability, and multi-dimensional feedback mechanism of knowledge service systems. Addressing these characteristics, the disclosure adopts generative chain of thought and dynamic feedback optimization technology, which can effectively solve the intelligent query and reasoning difficulties in complex scenarios, achieving precise, real-time, and credible knowledge services.

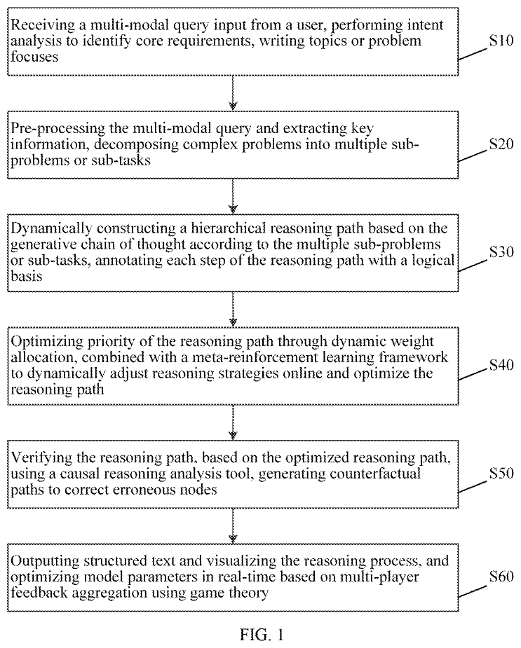

Referring to FIG. 1, an embodiment of the disclosure discloses a knowledge exploration method based on a generative chain of thought and feedback mechanism, including the following steps S10 to S60.

In S10, receiving, from a user, a multi-modal query input, performing intent analysis to identify core requirements, writing topics or problem focuses;

The method can be implemented through a software program, for example, as an interactive query platform system, providing a user-friendly interface that supports users inputting questions or needs in natural language. The user first inputs writing requirements through the system interface; these requirements can be specific writing instructions, natural language descriptions, or queries raised in the form of questions (QA). Upon receiving the input, the system immediately performs intent analysis, parsing the user's input to identify core requirements, writing topics or problem focuses, thereby providing a clear direction for subsequent processing.

S20, pre-processing the multi-modal query and extracting key information, decomposing complex problems into multiple sub-problems or sub-tasks;

After completing the intent analysis in step S10, the system pre-processes the user-input Query, including natural language processing operations such as word segmentation and part-of-speech tagging, to extract key information. Subsequently, the system uses natural language processing technology to further extract keywords and key terms from the Query, which will serve as the basis for reasoning path generation. For complex problems, the system also decomposes the Query into multiple sub-problems or sub-tasks to facilitate subsequent hierarchical reasoning.

S30, dynamically constructing a hierarchical reasoning path based on the generative chain of thought according to the multiple sub-problems or sub-tasks, annotating each step of the reasoning path with a logical basis;

In this step, based on generative chain of thought technology, the system dynamically constructs a hierarchical reasoning path. The reasoning path starts from the user-input Query and is gradually decomposed into multiple sub-tasks, each sub-task corresponding to a node in the reasoning path. The system annotates each step of the reasoning path with a clear logical basis, such as causal relationships, rule matching, or semantic associations. These logical bases provide the foundation for subsequent weight allocation and optimization. The preliminary reasoning path is presented in a hierarchical structure, ensuring that complex problems can be solved step by step.

S40, optimizing priority of the reasoning path through dynamic weight allocation, combined with a meta-reinforcement learning framework to dynamically adjust reasoning strategies online and optimize the reasoning path;

In this step, the system calculates the weight of each reasoning node through a dynamic weight allocation mechanism. Weight allocation considers task context, semantic similarity, and node importance, ensuring that key nodes and important logical relationships are prioritized. Based on the dynamic weights, the system readjusts the priority of the reasoning path, optimizing the efficiency and accuracy of the reasoning path. During the reasoning process, the system also dynamically adjusts weight allocation based on intermediate results to further optimize the reasoning path.

The optimized reasoning path then enters a meta-reinforcement learning framework for online optimization. The meta-reinforcement learning framework utilizes real-time user feedback and historical data to dynamically adjust reasoning strategies to adapt to new tasks and changing input scenarios. Through policy gradient updates and adversarial sample generation, the system continuously optimizes the response speed and accuracy of the reasoning path. At the same time, the meta-reinforcement learning framework combines causal reasoning analysis tools to further strengthen the correctness of causal relationships in the reasoning path, avoiding erroneous conclusions caused by misjudgment of correlations.

Among them, the dynamic weight allocation mechanism and the meta-reinforcement learning framework are specifically as follows:

### 1. Reasoning Path Generation Mechanism Based on Dynamic Weight Allocation

Traditional chain of thought generation relies on fixed rules or single-modal input, while this system achieves real-time optimization of reasoning paths and multi-modal collaborative reasoning through a dynamic weight allocation algorithm and a cross-modal joint embedding space, specifically including:

### Dynamic Reasoning Node Weight Calculation:

An adaptive weight allocation formula based on task context is proposed, transforming the traditional static path selection into a dynamic optimization problem:

$${w}_{i} = \frac{exp ( sim ( q , {n}_{i} ) / τ )}{{\sum }_{i = 1}^{j} exp ( sim ( q , {n}_{i} ) / τ )}$$

wᵢ: represents the weight of reasoning node nᵢ.
q: represents the current query task.
nᵢ: represents the i-th reasoning node.
j: represents the number of all reasoning nodes in the current path;
sim(q, nᵢ): represents the semantic similarity between the current task q and the reasoning node nᵢ.
τ: temperature coefficient, used for controlling the intensity of path exploration.

### Multi-Modal Joint Reasoning Path Generation:

A joint embedding method based on cross-modal alignment loss addresses the fusion deviation problem of multi-modal information (text, image, voice).
Taking text and image as an example below, the alignment loss function is defined as:

$${L}_{align} = - \frac{1}{N} {\sum }_{a = 1}^{N} {\sum }_{b = 1}^{M} {II}_{ab} \cdot log ( \frac{exp ( cos ( {f}_{T} ( {T}_{a} ) , {f}_{I} ( {I}_{b} ) / τ )}{{\sum }_{k = 1}^{M} exp ( cos ( {f}_{T} ( {T}_{a} ) , {f}_{I} ( {I}_{k} ) / τ} )$$

wherein, II_{ab}∈{0,1} is the modality correlation indicator function, which is 1 when the text Tₐ is related to the image I_{b}, otherwise 0.
f_{T}(·) and f_{I}(·) are the text encoder and image encoder respectively, outputting normalized embedding vectors.
Iₖ represents the k-th sample in the image modality; k∈(1,M), but k≠b;
cos(·,·) represents cosine similarity, τ is the temperature coefficient (set to 0.07 experimentally).
N is the number of text samples, M is the number of image samples.

Objective: Achieve cross-modal semantic alignment by maximizing the similarity of related text-image pairs and minimizing the similarity of unrelated pairs.

Normalization and temperature coefficient: The embedding vectors are L2 normalized, and the temperature coefficient t controls the sharpness of the similarity distribution to avoid gradient saturation.

The system can generate a logical reasoning path based on the query question input by the user and finally arrive at an answer to the question. The key lies in dynamically constructing the reasoning path, i.e., in the context of each question, the reasoning chain should be automatically generated and adjusted at any time according to the content of the query.

According to the query type, complex problems are broken down into multiple actionable sub-tasks or sub-problems. For legal domain problems, tasks may include sub-tasks such as legal provision retrieval, responsible subject analysis, and case retrieval.

According to the problem type (e.g., legal liability, medical issues, business decisions, etc.), the system selects an appropriate reasoning framework. These reasoning frameworks include rule-based reasoning and knowledge reasoning.

The core idea of reasoning path construction is to dynamically select sub-tasks of the reasoning path based on the specific needs of the user's query, and adjust the path according to intermediate results. Assume the system has multiple reasoning nodes n₁, n₂, . . . , nₖ, each node representing a reasoning task; k represents the number of nodes in the current path. For a given input query, path selection is determined by the following dynamic weight allocation:

$$P ( T ) = {\sum }_{i = 1}^{k} {w}_{i} \cdot {R}_{i} ( T )$$

wherein, T is the query task, Wᵢ is the weight of node ni, Rᵢ(T) is the reward value of the node (calculated according to the validity and efficiency of the current reasoning result). Path selection is accomplished by maximizing the total reward of the path:

$${P}^{*} = arg {max}_{p} ( {\sum }_{i = 1}^{k} {w}_{i} \cdot {R}_{i} ( T ) )$$

wherein, p represents a dynamically adjusted normalized weight coefficient, p∈[0,1].

### 2. Online Optimization Framework for Reasoning Path Based on Meta-Reinforcement Learning

Addressing the lag issue of traditional feedback mechanisms, a hybrid architecture of meta-reinforcement learning and online supervised learning is proposed to achieve real-time correction of reasoning paths and long-term stability optimization:

### Two-Stage Meta-Learning Strategy:

Offline meta-pre-training: Using the MAML (Model-Agnostic Meta-Learning) framework, the model is pre-trained on a cross-domain task set (legal, medical, financial) to equip it with the ability to quickly adapt to new tasks.

Online fine-tuning: Generating adversarial samples through real-time user feedback to dynamically update model parameters, addressing the domain drift problem.

### Multi-Objective Reward Function Design:

A composite reward mechanism integrating interpretability indicators is proposed:

$$R = {λ}_{1} \cdot Accuracy + {λ}_{2} \cdot Efficiency + {λ}_{3} \cdot Interpreta bility + {λ}_{4} \cdot UserSatisf action$$

wherein, λ₁, λ₂, λ₃, λ₄ are weight coefficients, Accuracy represents accuracy, Efficiency represents efficiency, Interpretability represents interpretability, and UserSatisfaction represents user satisfaction. The optimal combination is determined through Pareto frontier analysis, satisfying λ₁+λ₂+λ₃+λ₄=1. A time decay factor r=0.95 dynamically adjusts the weight of user satisfaction to ensure long-term stable system performance.

For each relation r, the system generates structured mapping rules by defining its corresponding entity category E ner in a template:

$$SchemaNER ( r ) = \{ ( h , t ) \vert h ∈ HeadEntiti es ( r ) , t ∈ TailEntiti es ( r ) \}$$

For example, for the relation r=“liability”, it defines as follow:

$$SchemaNER ( “ liability ” ) = \{ ( “ company ” , “ employee ” ) , ( “ legal person ” , “ shareholder ” ) \}$$

The model is guided to generate SchemaNER through task examples, ensuring the standardization and consistency of entity prediction.

To help the large language model understand the generation context of the named entity schema, a task background prompt can be provided to the model. This prompt contains background information of a specific domain, aiming to guide the large model to better understand and generate the correct entity schema in tasks involving law and liability classification.

Task background prompt: The task background prompt provides the large model with background information for generation, including the specific definition of the potential relation r, examples of the entity category E ner, and relevant legal context. By providing the task background prompt, the system can guide the model to be more precise when handling entity annotation, reducing irrelevant predictions and focusing on the target task.

Template filling and data generation: The template filling process guides the model to generate the corresponding SchemaNER by providing task examples. For example, given a potential relation in the task description, such as “company's liability towards employees”, the template will automatically fill in the entity categories and generate a schema containing “company” and “employee” as head and tail entities, ultimately generating a complete named entity schema, SchemaNER.

The system can ensure that each potential relation accurately matches relevant legal provisions and entities when generating the named entity schema. This typical mapping defines the structured mapping between relations and entities, ensuring the standardization and consistency of annotation.

Example mapping: Assuming a certain legal provision involves liability issues between a “company” and an “employee”, the system defines “company” and “employee” as potential entity categories in the named entity template through the mapping relationships “company-liability” and “employee-liability”, helping subsequent NER models understand their semantic roles.

Relation constraints: By defining the potential relation r in the task, the system provides a clear boundary for entity prediction for the model. For example, the task background prompt explicitly stipulates that the “liability” relation can only involve the two entities, company and employee, thereby reducing predictions of other irrelevant entities.

Over-prediction control: Through the mapping control between relations and entities, the system can ensure that the output of the large model is limited to task-related entities, avoiding the generation of irrelevant or redundant entity categories. This enables the model to be more focused and precise when handling complex legal relationships.

S50, verifying the reasoning path, based on the optimized reasoning path, using a causal reasoning analysis tool, generating counterfactual paths to correct erroneous nodes;

Based on the optimized reasoning path, the system further identifies and verifies the causal relationships between variables in the reasoning path using a causal reasoning analysis tool. Through counterfactual path analysis, the system compares the differences between the actual path and the counterfactual path, locates erroneous reasoning nodes, and triggers correction. At the same time, causal probability edges are embedded in the knowledge graph to define the causal strength between nodes, further enhancing the interpretability and credibility of the reasoning path.

Among them, the causal-driven reasoning path correction technology is as follows:
To address the credibility issue of black-box models, causal intervention techniques are introduced to construct a traceable reasoning chain correction process:
   WCounterfactual path analysis:

When the reasoning result deviates from expectations, the system automatically generates a counterfactual query:
“If the conclusion of node N_K is ignored, how will the result change?”

By comparing the differences between the actual path and the counterfactual path, erroneous reasoning nodes are located and correction is triggered.

### Causal Graph Reinforcement:

Causal probability edges are embedded in the knowledge to define the causal strength between nodes: For example, this technology enables the system to identify confounding variables and output causal explanations in scenarios such as medical liability determination. By calculating a logical consistency score, a task relevance score, a case support score and an interpretability score, the reasoning credibility and interpretability are enhanced.

Logical consistency score: Calculates the logical coherence between steps in the reasoning chain to ensure that no contradictory conclusions appear.

Task relevance score: Calculates the relevance between the user query and the generated chain of thought through vector similarity. Combined with a pre-trained language model, it calculates the degree of match between the generated content and the target question.

Case support score: Retrieves relevant legal cases through a case database and calculates the support for the current reasoning chain. If the reasoning chain highly matches known legal cases, a higher score is given to enhance reasoning credibility.

Interpretability score: Evaluates whether the reasoning chain provides sufficient intermediate reasoning steps so that the final conclusion can be verified. If the reasoning path is transparent and convenient for manual review, a higher score is given.

To improve the accuracy and robustness of the reward model, this embodiment adopts a reinforcement learning method for optimization. A policy gradient method is used to optimize the reasoning path of the large model, making it more compliant with the scoring criteria of the reward model. Multiple candidate reasoning paths are generated autoregressively, and the path with the highest score is selected as the final output. Combined with manually annotated high-quality reasoning chains, the reward model is fine-tuned to make it more consistent with the judgment standards of legal experts.

In each step of generating the reasoning path, the system optimizes the reasoning chain through a reward model. The reward mechanism is as follows:

$$R = {w}_{1} \cdot Accuracy + {w}_{2} \cdot Efficiency - {w}_{3} \cdot Re sources$$

w₁: is the weight coefficient for Accuracy. It represents the importance of the accuracy of the reasoning chain in the reward model. Accuracy usually refers to the degree of consistency between the reasoning result and the actual result or a known correct answer. A higher accuracy weight means the system tends to prefer paths that can provide correct or precise reasoning results.

Accuracy: refers to the accuracy score of the reasoning chain, which can be calculated by comparing the degree of match between the reasoning result and the real situation or known cases. In a legal reasoning system, this involves multiple aspects such as the logical consistency score, task relevance score, and case support score.

w₂: is the weight coefficient for Efficiency. It represents the importance of the efficiency of the reasoning process in the reward model. Efficiency usually refers to the time and resources required to complete the reasoning. Higher efficiency means the system can generate reasoning results faster.

Efficiency: refers to the efficiency score of the reasoning chain, which can be evaluated by calculating the time required for the reasoning process, consumption of computing resources, etc. In practical applications, improving efficiency can help the system respond to user queries more quickly, thereby enhancing user experience.

w₃: is the weight coefficient for Resource Consumption (Resources). It represents the importance of the negative impact of resource consumption during the reasoning process in the reward model. Resource consumption usually refers to the computing resources, storage space, etc., required to complete the reasoning.

Resources: refers to the resource consumption score of the reasoning chain, which can be calculated by evaluating the computing resources, storage requirements, etc., used during the reasoning process. In resource-constrained environments, reducing resource consumption can improve system scalability and cost-effectiveness.

S60, outputting structured text and visualizing the reasoning process, and optimizing model parameters in real-time based on multi-player feedback aggregation using game theory.

After the reasoning path has been verified and reinforced by causal reasoning, it finally enters the text generation step. Based on the optimized reasoning path, the system generates text content that meets the user's needs and outputs it in a structured form. The generated text not only satisfies the user's writing requirements but also comes with a detailed explanation of the reasoning process. The reasoning logic is intuitively displayed through timelines, causal relationship diagrams, etc., enhancing the transparency of the results and the user's trust in the system.

Users evaluate the generated text content, providing feedback on the quality of the system's output. The system first processes the user evaluations through a multi-player feedback aggregation algorithm based on game theory, quantifies each user's feedback contribution, and coordinates the evaluation opinions of different users, thereby ensuring the fairness and stability of the optimization process. Subsequently, the system utilizes a meta-reinforcement learning framework to process the aggregated feedback information in real time, dynamically adjusting the reasoning path and model parameters to adapt to the diverse needs of users. Based on user feedback, the system further continuously updates model parameters through online supervised learning, continuously improving the stability and long-term performance of the reasoning path. Through this closed-loop optimization mechanism, the system can accurately meet user needs, realizing intelligent knowledge exploration and text generation services.

Among them, the above-mentioned multi-player feedback aggregation algorithm based on game theory is explained as follows:

To address the problem of conflicting feedback from multiple users, a Shapley value feedback aggregation mechanism is proposed to ensure the fairness and stability of the optimization process:

### Quantification of Feedback Contribution:

$${ϕ}_{u} ( v ) = {\sum }_{S ∈ H ∖ \{ u \}} \frac{\vert S \vert ! ( \vert H \vert - \vert S \vert - 1 ) !}{\vert H \vert !} [ v ( S ⋃ \{ u \} ) - v ( S ) ]$$

where, φᵤ (v) represents the feedback contribution of user u, and v(S) represents the feedback value of user subset S, used for filtering low-quality or malicious feedback. H represents the set of all users participating in the feedback, and ! represents factorial.

When the query contains multiple modalities (such as text, image, audio, etc.), the system fuses information from various modalities by introducing a joint embedding space. For example, assuming T represents the text modality and I represents the image modality, the system can unify the representation of the two modalities through the following joint embedding Cc:

$${e}_{c} = f ( T , 1 ) = α \cdot {f}_{T} ( T ) + ( 1 - α ) \cdot {f}_{I} ( I )$$

wherein, f_{T} (T) and f_{I}(I) are the embedding representations of text and image respectively, α∈[0.1] is a weighting coefficient used to control the degree of information fusion between text and image. This fusion method ensures that information from different modalities can jointly influence path selection in the reasoning path, thereby improving the flexibility and accuracy of the reasoning chain.

Vector representation: Word embedding and semantic embedding technologies not only convert entities into vectors but also capture the semantic relationships between entities. For example, the relationship between “company” and “legal person” will have a high similarity in the vector space, while the relationship between “company” and “fine” will have a low similarity. The system determines the semantic relationship between entities through similarity measures between these vectors, thereby providing a basis for subsequent reasoning and chain of thought generation.

The system adjusts the vector representation according to the input query and context. When processing user queries, the model can dynamically update vectors based on user feedback to optimize semantic understanding. For example, for a user query “scope of company liability,” the system will understand the specific meanings of “company” and “liability” in different legal fields (such as civil law or criminal law) through the large model, adjust the vector representation, and generate a more suitable thought path.

When facing new tasks, the system quickly adjusts the reasoning path through transfer learning and meta-learning techniques. Through MAML in meta-learning, the reasoning path can quickly adapt to new query requirements from a small amount of task data:

$${θ}^{*} = arg {min}_{θ} {E}_{T ∼ d ( T )} [ {L}_{T} ( {f}_{{θ}^{′}} ( T ) ) ]$$

θ* represents optimizing the model parameters θ through meta-learning to minimize the expected loss over the task distribution d(T). d(T) is the task distribution, representing the probability distribution of all possible tasks. E T~d(T) represents taking the expected value of the loss L T for all tasks T.

where, θ is the model parameter, θ′ is the model parameters after task adaptation, LT is the loss function for task T. By training an initialization parameter θ, the model can obtain the optimal solution through a small amount of data adjustment when encountering a new task.

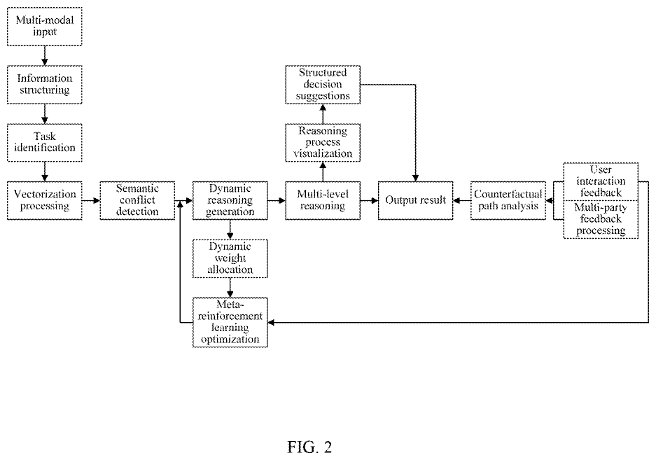

Referring to FIG. 2, the entire technical process of the method from multi-modal input to final output result, and how to optimize this process through feedback, is described:
multi-modal input: Receiving input data from different modalities, such as text, image, and voice.

Information structuring: The input information is structured to facilitate subsequent processing. This step ensures the organization and format of the information, making it suitable for machine processing.

Task identification: Identifying the user's specific task requirements, providing direction for subsequent reasoning and processing.

Vectorization processing: The information is converted into vector form to facilitate semantic processing. This step converts text, image, and voice data into numerical forms that can be processed by machine learning models.

Semantic conflict detection: Detecting semantic conflicts in the input information and processing them. This step ensures the consistency and accuracy of the information.

Dynamic reasoning path generation: Generating dynamic reasoning paths according to task requirements. This step allows the system to dynamically adjust its reasoning strategy according to the specific task.

Dynamic weight allocation: Allocating weights to each node in the reasoning path to optimize the reasoning process. This step improves the efficiency and accuracy of reasoning by adjusting the importance of different reasoning steps.

Meta-reinforcement learning optimization: Using meta-reinforcement learning techniques to optimize the reasoning path, improving the system's adaptability and efficiency. This step continuously improves the reasoning process by learning optimal strategies.

Multi-level reasoning: Performing multi-level reasoning to arrive at the final result. This step improves the depth and breadth of reasoning by deeply analyzing and synthesizing information from different levels.

Reasoning process visualization: Visualizing the reasoning process for user understanding. This step improves the interpretability of the results by graphically displaying the reasoning process.

Output result: Outputting the reasoning result to the user. This step ensures the result is clear and easy to understand.

Counterfactual path analysis: Analyzing possible counterfactual paths to optimize the reasoning process. This step improves the system's flexibility and adaptability by exploring different reasoning paths.

User interaction feedback: Collecting user feedback, including explicit and implicit signals. This step provides a basis for system optimization by collecting user feedback on the results.

Multi-party feedback processing: Processing user feedback from different aspects to further optimize the system. This step improves the comprehensiveness and accuracy of the system by synthesizing feedback from different sources.

Structured decision suggestions: Providing structured decision suggestions based on the reasoning results. This step improves the practicality of the results by converting the reasoning results into specific action suggestions.

Reasoning process backtracking: Allowing users and the system to backtrack the reasoning process for understanding and improvement. This step improves the transparency and interpretability of the system by providing a detailed record of the reasoning process.

The disclosure deeply integrates a reasoning path generation mechanism based on dynamic weight allocation, meta-reinforcement learning, a reasoning path optimization framework based on meta-reinforcement learning, causal reasoning, a multi-player feedback aggregation algorithm based on game theory, and interpretability enhancement technologies, significantly improving the performance of intelligent query and knowledge reasoning systems, providing reliable technical support for knowledge services in complex scenarios.

Reasoning Path Generation Mechanism with Dynamic Weight Allocation:

Through dynamic weight allocation, the disclosure can intelligently allocate the attention of different reasoning paths, prioritize key nodes, and ensure the logicality and efficiency of the reasoning process. This solves the problem of missing key points that may be caused by fixed weights in traditional methods.

### Meta-Reinforcement Learning and Reasoning Path Optimization Framework:

The meta-reinforcement learning framework allows the system to automatically adjust reasoning strategies during operation, adapting to dynamically changing input scenarios. This mechanism can quickly optimize reasoning paths in a real-time environment, improving accuracy and response speed.

### Causal Reasoning and Multi-Dimensional Correlation Analysis:

Based on causal reasoning technology, the system can identify the true causal relationships between variables, avoiding erroneous reasoning conclusions caused by correlations. This is particularly important for handling multiple causal relationships in complex texts.

### Multi-Player Feedback Aggregation Algorithm Based on Game Theory:

Addressing the diverse needs of different users, the system uses game theory methods to balance multi-party feedback and find the optimal reasoning result. This method can coordinate the views of different stakeholders and enhance the universality of the final conclusion.

### Interpretability Enhancement Technology:

Through interpretability enhancement technology, not only the final conclusion is output, but also the reasoning process and basis are displayed in detail, enhancing the transparency and credibility of the results.

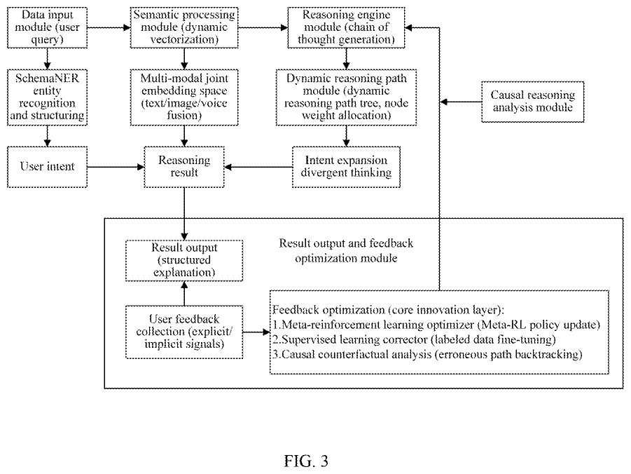

Based on the same inventive concept, an embodiment of the disclosure also provides a knowledge exploration system based on a generative chain of thought and feedback mechanism, referring to FIG. 3, comprising:
a data input module, configured to receive a multi-modal query input from a user, perform intent analysis to identify core requirements, writing topics or problem focuses;
a semantic processing module, configured to pre-process the multi-modal query and extract key information, decompose complex problems into multiple sub-problems or sub-tasks;
a reasoning engine module, configured to dynamically construct a hierarchical reasoning path based on the generative chain of thought according to the multiple sub-problems or sub-tasks, annotate each step of the reasoning path with a logical basis;
a dynamic reasoning path module, configured to optimize priority of the reasoning path through dynamic weight allocation, combined with a meta-reinforcement learning framework to dynamically adjust reasoning strategies online and optimize the reasoning path;
a causal reasoning analysis module, configured to, based on the optimized reasoning path, use a causal reasoning analysis tool to verify the reasoning path, generate counterfactual paths to correct erroneous nodes;
a result output and feedback optimization module, configured to output structured text and visualize the reasoning process, and optimize model parameters in real-time based on multi-player feedback aggregation using game theory.

As shown in FIG. 3, the system architecture depicts the complete process from data input to user feedback, as well as the interactions and data flow between various modules.

Among them, the data input module is the starting point for user interaction with the system, responsible for receiving user query requests, which can be multi-modal data in the form of text, images, or voice. It also performs SchemaNER entity recognition and structuring; after data input, the system uses SchemaNER technology to recognize and structure entities in the input data, performing intent analysis to identify core requirements, writing topics or problem focuses.

The semantic processing module can perform dynamic vectorization processing on the input information, responsible for converting the user's query into machine-understandable semantic vectors. Through multi-modal joint embedding space technology, the system can handle the fusion of text, image, and voice, achieving unified representation of information. It can pre-process multi-modal queries and extract key information, decomposing complex problems into multiple sub-problems or sub-tasks.

The reasoning engine module is used for chain of thought generation; this module is the core of the system, responsible for generating reasoning paths. It can dynamically construct hierarchical reasoning paths based on the generative chain of thought according to multiple sub-problems or sub-tasks, annotating each step of the reasoning path with a logical basis.

The dynamic reasoning path module dynamically generates reasoning paths according to task requirements through dynamic reasoning path tree generation technology, and performs node weight allocation; combined with the meta-reinforcement learning framework, it dynamically adjusts reasoning strategies online and optimizes the reasoning path; in addition, the system also expands the breadth and depth of reasoning through intent expansion divergent thinking technology to derive reasoning results.

The causal reasoning analysis module, based on the optimized reasoning path, uses causal reasoning analysis tools to verify the reasoning path, generating counterfactual paths to correct erroneous nodes;

The result output and feedback optimization module converts the reasoning results into structured explanations, presented in a user-friendly manner, making the results easy to understand and operate. User feedback collection (explicit/implicit signals) collects user feedback information. This feedback can be explicit (such as direct evaluations or suggestions) or implicit (such as click behavior or usage patterns). The feedback optimization part includes a meta-reinforcement learning optimizer (Meta-RL policy update), a supervised learning corrector (labeled data fine-tuning), and causal counterfactual analysis (erroneous path backtracking). These technologies are used to optimize reasoning paths and model parameters in real time, improving the system's adaptability and accuracy.

The knowledge exploration system based on a generative chain of thought and feedback mechanism provided by the disclosure is specifically designed for complex long-text scenarios and is applicable to the processing of formal, rigorous long texts such as legal regulations, academic papers, technical specifications/standard documents, government reports, contract documents, medical guidelines, financial reports, and user manuals. The solution of the disclosure is illustrated below through four application examples:

### Example 1, Intelligent Search and Retrieval System for Regulatory Provisions

Traditional regulatory information retrieval systems usually rely on simple keyword matching. This approach results in low relevance and precision of query results, especially when facing complex legal questions, making it difficult to screen out provisions that truly meet the requirements.

When applying the disclosure for searching or retrieving regulatory provisions, the system, through the reasoning path generation mechanism with dynamic weight allocation, combined with the semantic understanding and context analysis capabilities of regulatory provisions, can intelligently generate multi-level reasoning paths based on the query requirements input by the user. The system can develop reasoning paths from multiple dimensions, such as the scope of application of legal provisions, effective conditions, exceptions, etc., helping users quickly locate key legal provisions and related cases. Through dynamic weight allocation, the system can prioritize important provisions, reduce interference from irrelevant information, and achieve more precise retrieval results.

Furthermore, the system can also utilize meta-reinforcement learning technology to optimize the reasoning path based on user feedback. For example, when users mark certain results as “irrelevant” or “relevant,” the system will adjust the weight allocation strategy in real time, gradually optimizing the accuracy of the search results.

### Example 2, Legal Question Answering System

In legal question answering scenarios, questions raised by users often involve complex legal backgrounds and may require analysis synthesizing multiple laws, regulations, and judicial interpretations. Traditional systems find it difficult to correlate multiple regulatory provisions within the same query and cannot deeply explore the logical relationships between laws, resulting in incomplete answers.

When applying the disclosure as a legal question answering system, through dynamic reasoning path generation technology, the system can automatically generate dynamic reasoning paths based on the user's query, and combine regulatory provisions and rights-liability classification to form multi-level legal analysis. For example, when dealing with questions related to “corporate compliance review,” the system can not only cite relevant provisions of the “Company Law” but also combine relevant provisions of the “Administrative Penalty Law” and the “Civil Procedure Law” to construct a complete legal reasoning chain.

Furthermore, the system also supports a multi-round feedback optimization mechanism. Users can rate the answers or raise supplementary requests, and the system will dynamically adjust the reasoning path based on the feedback, gradually improving the quality and degree of personalization of the answers. This method is particularly suitable for handling complex legal matters, such as intellectual property disputes, contract performance disputes, etc.

### Example 3, Legal Literature Retrieval and Analysis System

Faced with a vast amount of legal literature (such as precedents, regulatory interpretations, lawyer opinions, etc.), traditional systems usually lack in-depth reasoning capabilities and semantic understanding, making it difficult to quickly locate the most relevant literature.

When performing legal literature retrieval and analysis based on the system of the disclosure, through intelligent query path generation and causal reasoning technology, it can identify logical relationships between literature, such as citation relationships of legal provisions, correspondence relationships between cases and legal clauses, etc., helping users quickly obtain the required information. For example, when retrieving applicable cases for a certain legal principle, the system can combine causal reasoning to screen out real cases related to it and sort them by importance.

Through the dynamic feedback mechanism, the system can also make intelligent recommendations based on user preferences and behavioral habits (such as frequently consulted regulatory fields, commonly used legal terms, etc.), further improving retrieval efficiency and reducing interference from invalid information.

### Example 4, Legal Consultation and Intelligent Customer Service

In legal consultation services, users may need personalized legal advice on specific issues. Traditional legal consultation systems can usually only provide static knowledge base content and cannot dynamically adjust according to the user's specific situation.

When applying the system of the disclosure for legal consultation, the system, by combining the feedback mechanism and the dynamic optimization framework, can generate personalized legal advice based on the user's query history and behavioral data. For example, when a user asks “how to handle a labor arbitration case,” the system will not only cite relevant provisions of the “Labor Law” but also combine local judicial practices and similar cases to provide more specific advice.

Furthermore, the system supports a multi-round interaction mode, capable of gradually refining the user's query requirements during the dialogue, and finally generating a complete legal analysis report. Users can also rate each step of the reasoning results, and the system will adjust the reasoning strategy for the next step based on the feedback, thereby continuously improving service quality.

The disclosure introduces a feedback mechanism based on meta-reinforcement learning to achieve real-time reasoning path optimization. Through user feedback, the system can dynamically adjust the weight allocation of the reasoning path and optimize the accuracy of query results. For example, the system can update weight parameters in real time through user ratings of results or behavioral data (such as click-through rates), gradually improving the relevance of retrieval results. To address the conflict problem of multi-user feedback, the system adopts a Shapley value feedback aggregation mechanism to ensure the fairness and stability of the optimization process. By quantifying each user's feedback contribution, the system can eliminate interference from low-quality feedback and optimize the selection strategy of reasoning paths.

In addition, the system also supports feedback-driven online supervised learning, continuously updating model parameters using user feedback to improve the stability and long-term performance of the reasoning path. For example, the system can generate adversarial samples after each user feedback, simulating reasoning paths under extreme conditions to test and correct potential reasoning deviations.

Each embodiment in this specification is described in a progressive manner, with each embodiment focusing on its differences from other embodiments. Reference may be made between similar parts of the embodiments. For the device disclosed in the embodiments, since it corresponds to the method disclosed in the embodiments, the description is relatively simple, and reference may be made to the description of the method part for relevant aspects.

The above description of the disclosed embodiments enables those skilled in the art to make or use the disclosure. Various modifications to these embodiments will be readily apparent to those skilled in the art, and the general principles defined herein may be implemented in other embodiments without departing from the spirit or scope of the invention. Therefore, the disclosure will not be limited to the embodiments shown herein but is to be accorded the widest scope consistent with the principles and novel features disclosed herein.

1. A knowledge exploration method based on a generative chain of thought and feedback mechanism, comprising:
S10, receiving, from a user, a multi-modal query input, and performing intent analysis to identify core requirements, writing topics or problem focuses;
S20, pre-processing the multi-modal query and extracting key information, decomposing complex problems into multiple sub-problems or sub-tasks;
S30, dynamically constructing a hierarchical reasoning path based on the generative chain of thought according to the multiple sub-problems or sub-tasks, annotating each step of the reasoning path with a logical basis;
S40, optimizing priority of the reasoning path through dynamic weight allocation, combined with a meta-reinforcement learning framework to dynamically adjust reasoning strategies online and optimize the reasoning path;
S50, verifying the reasoning path based on the optimized reasoning path, using a causal reasoning analysis tool, generating counterfactual paths to correct erroneous nodes;
S60, outputting structured text and visualizing the reasoning process, and optimizing model parameters in real-time based on multi-player feedback aggregation using game theory;
wherein, in step S40, optimizing the priority of the reasoning path through dynamic weight allocation further comprises:
dynamically calculating weights of nodes in the reasoning path according to task context, semantic similarity and node importance, the weight being calculated by the following formula:
$${w}_{i} = \frac{exp ( sim ( q , {n}_{i} ) / τ )}{{\sum }_{i = 1}^{j} exp ( sim ( q , {n}_{i} ) / τ )}$$
wherein, Wᵢ represents the weight of reasoning node nᵢ; q represents the current query task; nᵢ represents the i-th reasoning node; j represents the number of all reasoning nodes in the current path; sim(q, nᵢ) represents the semantic similarity between the current task q and the reasoning node nᵢ; τ represents a temperature coefficient for controlling path exploration intensity;
according to the multiple nodes decomposed from the reasoning path, each node corresponds to a sub-task, and optimal selection of the path is achieved by maximizing a total reward value through a reward model; wherein, the formula for maximizing the total reward value is as follows:
$${P}^{*} = arg {max}_{p} ( {\sum }_{i = 1}^{k} {w}_{i} \cdot {R}_{i} ( T ) )$$
wherein, T represents the query task, Rᵢ (T) represents the reward value of node i, k represents the number of nodes in the current path; p represents a dynamically adjusted normalized weight coefficient, p∈[0,1].

2. The knowledge exploration method based on a generative chain of thought and feedback mechanism of claim 1, wherein in step S40, the optimizing the priority of the reasoning path through dynamic weight allocation further comprises:
fusing multi-modal input information, achieving semantic alignment of text and images through an alignment loss function, the loss function being defined as:
$${L}_{align} = - \frac{1}{N} {\sum }_{a = 1}^{N} {\sum }_{b = 1}^{M} {II}_{ab} \cdot log ( \frac{exp ( cos ( {f}_{T} ( {T}_{a} ) , {f}_{I} ( {I}_{b} ) / τ )}{{\sum }_{k = 1}^{M} exp ( cos ( {f}_{T} ( {T}_{a} ) , {f}_{I} ( {I}_{k} ) / τ} )$$
II_{ab}∈{0,1} wherein, represents a modality correlation indicator function, which is 1 when the text Tₐ is related to the image I_{b}, otherwise 0; and f_{T} (·) and f_{I} (·) represent a text encoder and an image encoder respectively, outputting normalized embedding vectors; Iₖ represents the k-th sample in the image modality, k≠b; cos(·,·) represents cosine similarity, t represents a temperature coefficient; N represents the number of text samples, M represents the number of image samples.

3. The knowledge exploration method based on a generative chain of thought and feedback mechanism of claim 1, wherein in the step S40, the dynamically adjusting reasoning strategies online with the meta-reinforcement learning framework, comprising:
offline meta-pre-training, using a MAML framework to pre-train a model on a cross-domain task set;
online fine-tuning generating adversarial samples through real-time user feedback to dynamically update model parameters; and
integrating a composite reward mechanism having interpretability indicators, balancing reasoning accuracy, efficiency and interpretability through a multi-objective reward function.

4. The knowledge exploration method based on a generative chain of thought and feedback mechanism of claim 1, wherein in the step S50, the using a causal reasoning analysis tool to verify the reasoning path comprises:
generating counterfactual queries when reasoning results deviate, comparing an actual path with a counterfactual path to locate erroneous nodes and trigger correction; and
defining causal strength between nodes by embedding causal probability edges in knowledge, and calculating a logical consistency score, a task relevance score, a case support score and an interpretability score to enhance reasoning credibility and interpretability.

5. The knowledge exploration method based on a generative chain of thought and feedback mechanism of claim 4, wherein in the step S50, the verifying the reasoning path using a causal reasoning analysis tool further comprises:
in each step of generating the reasoning path, optimizing a reasoning chain through a reward model, the reward mechanism being as follows:
$$R = {w}_{1} \cdot Accuracy + {w}_{2} \cdot Efficiency - {w}_{3} \cdot Re sources$$
wherein w₁ represents a weight coefficient for accuracy; Accuracy represents an accuracy score of the reasoning chain; w₂ represents a weight coefficient for efficiency; Efficiency represents an efficiency score of the reasoning chain; w₃ represents a weight coefficient for resource consumption; Resources represents a resource consumption score of the reasoning chain.

6. The knowledge exploration method based on a generative chain of thought and feedback mechanism of claim 1, wherein in the step S60, the optimizing model parameters in real-time based on multi-player feedback aggregation using game theory comprises:
quantifying user feedback contributions based on a Shapley value algorithm of game theory, filtering low-quality or malicious feedback, coordinating multiple user opinions to optimize the reasoning path; and
utilizing the meta-reinforcement learning framework to process aggregated feedback information in real time, dynamically adjusting the reasoning path and model parameters.

7. A knowledge exploration system based on a generative chain of thought and feedback mechanism, applying the knowledge exploration method of claim 1, wherein the system comprises:
a data input module, configured to receive a multi-modal query input from a user, perform intent analysis to identify core requirements, writing topics or problem focuses;
a semantic processing module, configured to pre-process the multi-modal query and extract key information, decompose complex problems into multiple sub-problems or sub-tasks;
a reasoning engine module, configured to dynamically construct a hierarchical reasoning path based on the generative chain of thought according to the multiple sub-problems or sub-tasks, annotate each step of the reasoning path with a logical basis;
a dynamic reasoning path module, configured to optimize priority of the reasoning path through dynamic weight allocation, combined with a meta-reinforcement learning framework to dynamically adjust reasoning strategies online and optimize the reasoning path;
a causal reasoning analysis module, configured to, based on the optimized reasoning path, use a causal reasoning analysis tool to verify the reasoning path, generate counterfactual paths to correct erroneous nodes; and
a result output and feedback optimization module, configured to output structured text and visualize the reasoning process, and optimize model parameters in real-time based on multi-player feedback aggregation using game theory.
